(19) United States
(12) Patent Application Publication
(10) Pub. No.: US 2025/0025928 A1
(43) Pub. Date: Jan. 23, 2025

(54) METHOD FOR MANUFACTURING LAMELLAS FOR A LAMINATION

(71) Applicant: Robert Bosch GmbH, Stuttgart (DE)

(72) Inventors: Robert Van Den Heuvel, Tilburg (NL); Peter Nouws, Tilburg (NL); Gert Jansen, Tilburg (NL); Arjen Brandsma, Tilburg (NL)

(21) Appl. No.: 18/717,722

(22) PCT Filed: Dec. 27, 2022
(86) PCT No.: PCT/EP2022/025598

§ 371 Date: Jun. 7, 2024

(30) Foreign Application Priority Data
Dec. 30, 2021 (NL) 2030371

(51) Int. Cl. B21D 28/10; B21D 28/22; H02K 15/02

(52) U.S. Cl. CPC B21D 28/10; B21D 28/22; H02K 15/02

(57) ABSTRACT

The present invention relates to a method for manufacturing lamellas (20) from sheet metal (30) for a stack of such lamellas (20), i.e. a lamination, such as the core of a transformer or of a rotor or a stator of an electric machine. According to the present invention, in a first manufacturing step (A), the individual lamellas (20) are only partly cut loose from the sheet material (30), while connecting tabs (32) are left between the lamellas (20) and a remaining frame part (31) of the sheet material (30). As a result, the lamellas (20) can be subsequently processed (SP) separately, favorably without requiring the individual and/or direct handling thereof. Only thereafter, in second manufacturing step according to the present invention (B), the lamellas (20) are completely cut loose from the frame part (31) of the sheet material (30) by cutting the said connecting tabs (32) there between.

### BACKGROUND

The present invention relates to a method for manufacturing lamellas from sheet material, in particular metal such as electrical steel, for a stack of such lamellas, i.e. a lamination, such as the core of a transformer or of a rotor or a stator of an electric machine. In the latter case, the lamellas are typically (but not necessarily) either disc shaped (rotor core) or ring shaped (stator core). At least in these latter, electrical applications of the lamination stack, the individual lamellas thereof typically have a thickness that is small compared to their other dimensions, often having an absolute value in the thickness range between 0.05 to 0.5 mm. The present invention in particular relates to lamellas having a largest dimension that amounts to at least 500 up to 2500 times their thickness dimension.

The lamellas of the lamination stack are individually obtained from sheet material by means of stamping, i.e. blanking. This process step of lamella blanking is typically preceded by one of more successive punching, i.e. piercing steps, wherein holes for accommodating shafts, bolts, magnets or wire windings and/or weight reduction or cooling holes are formed in the sheet material. These individually blanked lamellas are mutually stacked in a desired amount to form the stack thereof. In this latter respect, it is a well-known practice to form the lamination stack, i.e. to mutually stack the lamellas thereof as part of the process step lamella blanking. That is to say that the lamellas are successively blanked from a continuously supplied strip of sheet material with a later blanked lamella being stacked on top of earlier blanked lamellas by the same action of the blanking punch, as whereby this is cut from the sheet material. JP 2005-191031 A provides an example of such well-known practice that has the advantage that the blanked lamellas need not be individually (and delicately) handled. Nevertheless, an obvious disadvantage of JP 2005-191031 A is that the lamellas cannot be processed separately, in particular not locally at the individual main (i.e. top and bottom) faces thereof.

Against the above known technical background, the present invention aims to provide a method for manufacturing the lamination stack that, on the one hand, enables the processing of the main faces of the lamellas thereof and that, on the other hand, avoids the problems associated with the individual handling of these lamellas.

### SUMMARY

According to the invention, in a first step of the said novel manufacturing method, the individual lamellas are only partially cut loose from the sheet material, while connecting tabs, i.e. bridges are left between the lamellas and a remaining frame part of the sheet material (or between two directly adjacent lamellas, i.e. without any sheet material remaining between such directly adjacent lamellas). By these bridges, the lamellas remain connected to, in particular remain integral with such frame part. As a result, the lamellas, in particular the main faces thereof, can be subsequently processed separately, favorably without requiring the individual and/or direct handling thereof. Instead, the lamellas are favorably handled indirectly via the said frame part of the sheet material. For example, the frame part can be conveniently pulled (or pushed and pulled simultaneously) to transport the lamellas to, from or in subsequent process steps. Moreover, to facilitate and/or economize such transport, such subsequent processing, or to enable storage and/or buffering, the frame part with the partially cut lamellas can be conveniently reeled-up into a coil.

In particular according to the invention, the lamellas are partially cut loose from the sheet material by piercing the sheet material along the outer contour of the lamellas and in between the said connecting bridges. In this case, multiple, mutually spaced elongated holes are formed in the sheet material along the outer contour of the lamellas. The sheet material that is left behind between such elongated holes thus forming the said connecting bridges between the lamellas and the said frame part of the sheet material or between two directly adjacent lamellas.

It is noted that the said first step of the novel manufacturing method can in principle be caried out simultaneous with the said one of more successive piercing steps for forming holes in the body of the lamellas (i.e. inside the outer contour thereof). Nevertheless, these latter piercing steps are preferably completed before the said first step of the novel manufacturing method is carried out. Moreover, the said first step can itself be carried out in multiple, i.e. separate and subsequent piercing (sub-) steps.

Further according to the invention, 4 or more bridges are left between each lamella and the frame part of the sheet material that are preferably essentially equally spaced along the outer contour thereof. Moreover, at least 4 of the bridges are preferably at least partly oriented between the lamella and the said frame part (or a directly adjacent lamella) in a direction wherein the sheet material is supplied, with 2 bridges located on either side of the lamella as seen in such supply direction. By these features, a deformation of the lamellas—that might otherwise occur when the frame part is pulled and/or pushed to transport these in the said supply direction—can be favorably avoided. For the same reason, the bridges are preferably arranged mirror-symmetrically relative to a virtual centerline of the lamella oriented in the said supply direction and possibly also relative to a virtual centerline of the lamella oriented perpendicular to the said supply direction.

The number is bridges per lamella is preferably limited to facilitate the removal thereof in a later process step of the process lamination stack manufacturing method. In this latter respect, it has been determined that applying more than 20 bridges per lamella does typically not add benefit.

Specifically for essentially circular-shaped lamellas of diameter D and having a thickness in the said 0.05 to 0.5 mm range, the number of bridges NB is preferably selected from the range defined by:

$$( π \cdot D ) / 85 mm < NB < ( π \cdot D ) / 45 mm , \qquad ( 1 )$$

albeit, within the said constraints of at least 4 and at most 20 bridges.

Alternatively and in case the design of the lamella shows an R-fold rotational symmetry, the number of bridges NB is preferably set equal to ½, 1 or 2 times R, preferably likewise within the said constraints of at least 4 and at most 20 bridges.

At some point after the said first step of the novel manufacturing method, in particular after the subsequent processing of the lamellas in the frame part (i.e. while these are connected to the frame part via the said bridges) has been completed, the lamellas are separated, i.e. are completely cut loose from the frame part of the sheet material by shearing-off or otherwise cutting the bridges at the outer contour of the lamellas in a second step of the novel manufacturing method. For example, a laser cutting or a mechanical cutting process can be applied for this purpose. In particular, the lamellas can be cut loose by means of blanking that is known as such. In this case, however, only the bridges still need to be cut rather than the entire contour of the lamella, such that the required cutting force is favorably low as compared to conventional blanking. With blanking a high cutting accuracy can be realized and, moreover, the successively blanked lamellas can be conveniently stacked on top of one another in accordance with the well-known practice.

Preferably, the bridges coincide with, i.e. connect to a respective lamella at the location of an indent in the general circumference thereof. Thus, after cutting loose the lamellas, any part of the bridge that inadvertently remains connected to a lamella, such as due to cutting inaccuracy or a burr left after cutting, favorably does not immediately protrude beyond such general circumference of the lamella.

### BRIEF DESCRIPTION OF THE DRAWINGS

In the following, the lamination stack manufacturing method according to the present invention is explained further and in more detail by way of example embodiments and with reference to the drawings, whereof:

FIG. 1 provides two typical examples of known lamellas, namely a stator ring for a stator core lamination stack and a rotor disc for rotor core lamination stack of an electric motor;

FIG. 2 schematically illustrates the basic setup of the presently relevant part of a known lamination stack manufacturing method;

FIG. 3 schematically illustrates a first elaboration of a novel lamination stack manufacturing method according to the present invention;

FIG. 4 schematically illustrates two specific aspects of the novel lamination stack manufacturing method according to the present invention;

FIG. 5 schematically illustrates a second elaboration of the novel lamination stack manufacturing method according to the present invention; and

FIG. 6 schematically illustrates a third elaboration of the novel lamination stack manufacturing method according to the present invention;

### DETAILED DESCRIPTION

FIG. 1 provides two examples of lamellas 1 that can be suitably produced with the method for manufacturing a stack of metal lamellas discussed herein.

In the example depicted on the left side of FIG. 1, the lamella 1 takes the form of a stator ring 10 for an electric motor. In the electric motor a number of such stator rings 10 are stacked in axial direction to form a stator core lamination stack. In the presently illustrated, non-limiting, example of the stator ring 10, it is shown to include several holes 11 inside its circularly-shaped outer contour that are equally spaced along its circumference, which holes 11 for example serve to accommodate assembly bolts or to channel cooling liquid. Moreover, the inner contour of the stator ring 10 is shaped by a large number of radial inwardly extending pole teeth 12 with an equal number of radial slots 13 therebetween, which slots 13 serve to accommodate windings of electric wire in the electric motor.

In the other example of FIG. 1 that is depicted on the right side thereof, the lamella 1 takes the form of a rotor disc 20 of an electric motor. In the electric motor a number of such rotor discs 20 are stacked to form a rotor core lamination stack. In the presently illustrated, non-limiting, example of the rotor disc 20, it is shown to include a central hole 21 that defines the inner contour of the rotor disc 20 and that serves to accommodate a rotor shaft, extending in axial direction through the whole of the rotor core lamination stack while being fixed thereto in the electric motor. Moreover, within its circularly-shaped outer contour the rotor disc 20 is provided with eight sets of four holes 22 that serve to accommodate permanent magnets in the electric motor. These sets of four magnet holes 22 each, are equally spaced along the circumference of the rotor disc 20, i.e. with two adjacent such sets being arranged at a 45 degree angle relative to one another.

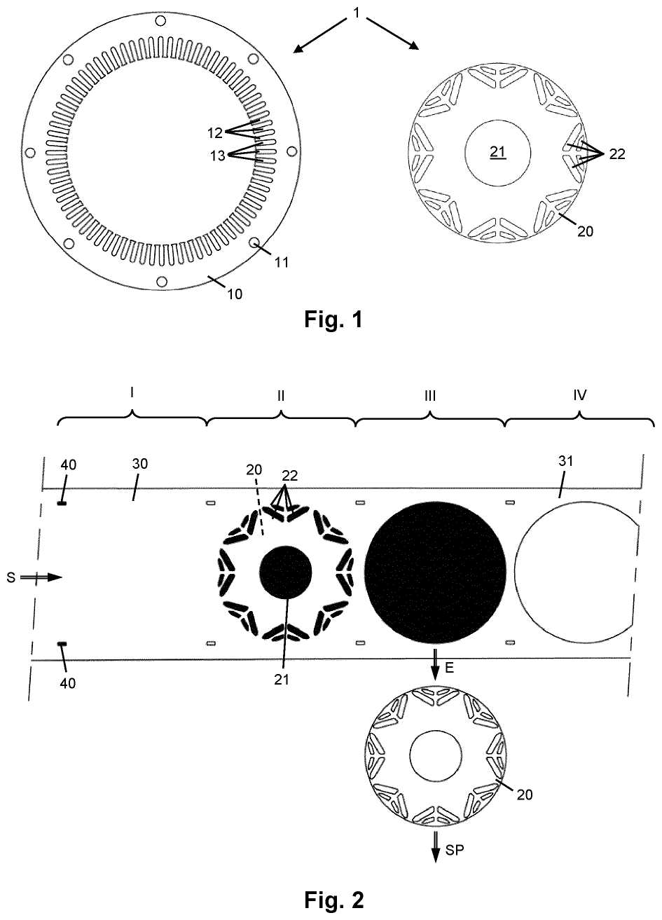

In FIG. 2 the basic setup of the presently relevant part of a known lamination stack manufacturing method is schematically illustrated in relation to the rotor disc 20 illustrated in FIG. 1 and in a plan view of a strip of sheet material 30. In this FIG. 2, as well as in the following drawing figures, the part or parts of the sheet material 30 that is or that are being cut and removed from the sheet material 30 in a respective process step, i.e. that are currently being pierced or blanked, are shaded. The sheet material 30 is supplied to a so-called progressive stamping device (not illustrated) in the direction of the arrow S, i.e. from the left to the right in FIG. 2, in the form of a continuous strip that is typically reeled-off from a coil.

In a first step I of the known method, a set of pilot holes 40 are pierced through the sheet material 30 on either side thereof by means of piercing punch-and-die-pairs of the progressive stamping device. These pilot holes 40 are used to receive locating pins (not illustrated) later on in the progressive stamping device (i.e. towards to right in FIG. 2) that serve to align the sheet material 30 inside the device. In a second step II of the known method, further (sets of) holes 21, 22 are pierced through the sheet material 30 by means of further piercing punch-and-die-pairs, which further holes 21, 22 correspond to the shaft hole 21 and the magnet holes 22 of the—still to be cut—rotor disc 20. It is noted that, typically depending on the geometric complexity of the lamella 1, the said first and second steps I and II of the known lamination stack manufacturing method can be integrated into a single process step, subdivided into multiple process steps, or otherwise combined. For example in this respect, the piercing of the pilot holes 40 can be combined with the piercing of the shaft hole 21 in a first step, with the magnet holes 22 being pierced in a second step.

In a third step III of known method, the rotor disc 20 is cut from the sheet material 30 in a well-known manner by means of a blanking punch-and-die-pair of the progressive stamping device. The blanked rotor disc 20 is ejected from the progressive stamping device, as schematically indicated by the arrow E, and thereby either is placed directly on top of the rotor disc lamination stack or is transported individually for subsequent processing, as schematically indicated by the arrow SP, before such lamination stacking is carried out. In a fourth step IV of the known method, the remaining frame part 31 of the sheet material 30 exits the progressive stamping device.

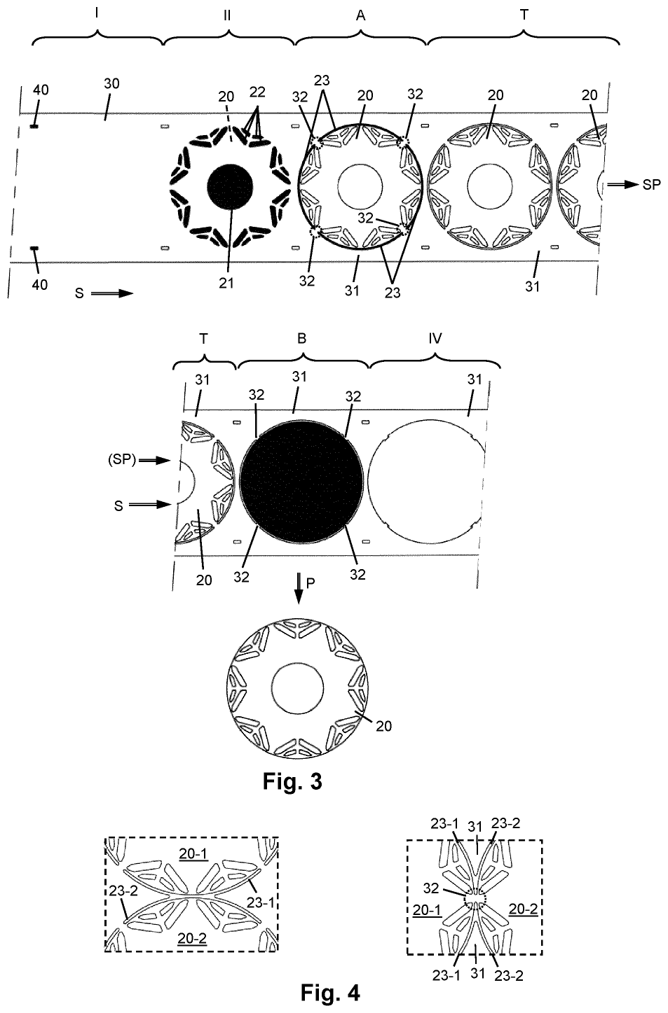

The present invention seeks to improve upon the known lamination stack manufacturing method. According to the invention such improvement is achieved with the novel lamination stack manufacturing method that is schematically illustrated in FIG. 3 in a first elaboration thereof.

The first and second steps II illustrated in FIG. 3 correspond to those illustrated in FIG. 2. However, thereafter, in a first step A of the novel method, multiple, mutually spaced elongated holes 23 are pierced through the sheet material 30, following the outer contour of the rotor disc 20, such that the rotor disc 20 remains an integral part of the sheet material 30. In other words, in this first novel step A, connecting bridges 32 remain between the rotor disc 20 and a frame part 31 of the sheet material 30, which connecting bridges 32 are defined by and between the said elongated holes 23. After such first novel step A, the rotor disc 20 exits the progressive stamping device while still connected to the frame part 31 sheet material 30 via the said bridges 32 for the convenient transport T and subsequent processing SP thereof. Such subsequent processing SP may include the annealing heat treatment of the rotor discs 20, the application of an adhesive thereto, and/or the coating thereof, in particular an electrically insulating coating, etc. (not illustrated).

In the embodiment of the invention illustrated in FIG. 3, four bridges 32 are left between each rotor disc 20 and the frame part 31 sheet material 30. Since in this embodiment the rotor disc 20 has an eight-fold rotationally symmetry R, this number of bridges equals ½R, as is preferred. Further in this embodiment, the four bridges 32 are equally spaced along the outer contour of the rotor disc 20, with two bridges 32 being present, mirror symmetrically relative to both the supply direction S and a direction perpendicular thereof, on either side of the rotor disc 20, as is likewise preferred. Additionally, the four bridges 32 are all advantageously at least partly oriented between the rotor disc 20 and the said frame part 31 in the supply direction S of the sheet material 30, rather than (exclusively) perpendicular thereto. By the features of the arrangement of the bridges 32, a deformation of the rotor disc 20—that might otherwise occur when the said frame part 31 is pulled in the supply direction S to transport, in particular reel-up the sheet material 30—can be favorably avoided.

At some point after the said first step A in the novel manufacturing method, in particular after the said subsequent processing SP thereof, the rotor disc 20 is transported T in the frame part 31 to the cutting device for their mutual separation in a second step B of the novel manufacturing method. Thus, in such second step B, the rotor disc 20 is completely cut loose from the frame part 31 of the sheet material 30 by shearing-off or otherwise cutting the bridges 32. In the illustrated embodiment, the rotor disc 20 is cut loose, i.e. the bridges 32 are severed from the outer contour of the rotor disc 20, by means of blanking. After being cut loose, the rotor disc 20 is preferably placed P directly on top of the rotor disc lamination stack. Also after the rotor disc 20 has been cut loose, the remaining frame part 31 of the sheet material 30 exits the cutting device corresponding to the said fourth step IV of the known method.

It is noted that, as illustrated on the left side of FIG. 4 in relation to two adjacent rotor discs 20-1 and 20-2, some of the said elongated holes 23-1 and 23-2 that following the respective contours thereof can in principle overlap, at least in part. Such overlap can be in the said supply direction S, but potentially also perpendicular thereto in case two or more parallel rows of rotor discs 20 are cut from—sufficiently wide—sheet material 30 simultaneously. In this case, very efficiency use is made of the sheet material 30, since the size of the said frame part 31 is reduced thereby. In particular, as illustrated on the right side of FIG. 4, the elongated holes 23-1 and 23-2 on both sides of a respective bridge 32 can be arranged to overlap, whereby such respective bridge 32 directly connects the said two adjacent rotor discs 20-1 and 20-2, rather than via the frame part 31.

Obviously, these latter two specific aspects of the invention are independent of the specific lamella shape and can thus be applied in general within the present context, i.e. not only in relation to rotor discs 20.

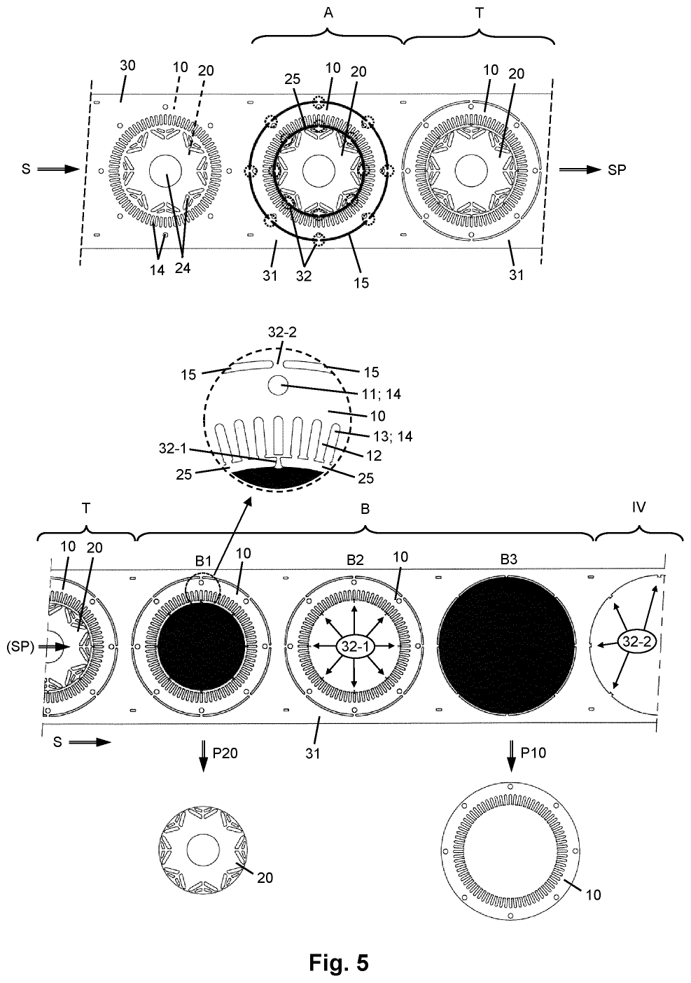

A second elaboration of the novel lamination stack manufacturing method according to the invention is schematically illustrated in FIG. 5. This second elaboration is particularly suited for the manufacture of both the stator lamination and the rotor lamination of an electric motor simultaneously. In particular in this second elaboration, each rotor disc 20 is cut from the sheet material 30 concentrically inside the inner contour of a respective stator ring 10 that is likewise (to be) cut from the sheet material 30. Hereby, efficient use is made of the sheet material 30, since the material on the radial inside of the stator ring 10 is not completely scraped, but instead is largely used for the manufacture of the rotor disc 20. Also this second elaboration of the novel lamination stack manufacturing method according to the invention starts with sheet material 30 that is prepared with the necessary stator holes 14 and rotor holes 24, the placement whereof is determined by the said mutually concentric arrangement of the—to be cut—stator ring 10 and rotor disc 20.

In the first step A of the embodiment of the invention illustrated in FIG. 5, two sets of eight, mutually spaced elongated holes 15, 25 are pierced through the sheet material 30. The holes 15 of the first set follow the outer contour of the—to be cut—stator ring 10 and the holes 25 of the second set follow both the inner circumference of the stator ring 10 and the outer contour of the rotor disc 20. Thus eight bridges 32 are left between the elongated holes 15, 25 of each set that respectively connect the stator ring 10 to the frame part 31 of the sheet material 30 and the rotor disc 20 to the stator ring 10. After such first novel step A, the stator ring 10 and the rotor disc 20 exit the progressive stamping device while still connected to the frame part 31 sheet material 30 via the said bridges 32 for the convenient transport T and subsequent processing SP thereof.

At some point after the said first step A in the novel manufacturing method, in particular after the said subsequent processing SP thereof, the stator ring 10 and the rotor disc 20 are transported T in the frame part 31 to a cutting device for their mutual separation in a second step B of the novel manufacturing method. Thus, in such second step B, the stator ring 10 and the rotor disc 20 are completely cut loose from the frame part 31 of the sheet material 30 and from each other by shearing-off or otherwise cutting the bridges 32. In the embodiment of the invention illustrated in FIG. 5, this second step B includes three stages B1, B2 and B3.

In a first stage B1 of the second step B, the rotor disc 20 is completely cut loose from the stator ring 10 by cutting a first set of bridges 32-1 at the outer contour of the rotor disc 20. After being cut loose, the rotor disc 20 is preferably placed directly on top of the rotor disc lamination stack, as schematically indicated by the arrow P20. In a second stage B2 of the second step B, the same, first set of bridges 32-1 again at the inner circumference of the stator ring 10, thereby finalizing the inner contour shape of that stator ring 10, while the said first set of bridges 32-1 is ejected from the cutting device as scrap. In a third and final stage B3 of the second step B, the stator ring 10 is completely cut loose from the frame part 31 of the sheet material 30 by cutting a second set of bridges 32-2 at its outer contour. After being cut loose, the stator ring 10 is preferably placed directly on top of the stator ring lamination stack, as schematically indicated by the arrow P10. Also after the stator ring 10 has been cut loose, the remaining frame part 31 of the sheet material 30 exits the cutting device corresponding to the said fourth step IV of the known method.

According to the present invention, the placement and the cutting-loose of the first set of bridges 32-1 are of particular importance to the operating performance of the end-product electric motor, in particular in terms of the optimum magnetic reluctance thereof. Therefore, preferably the cutting thereof in the said first and second stages B1, B2 of the of the second step B is carried out with high accuracy, in particular with higher accuracy compared to the cutting of the second set of bridges 32-2. Ideally, the first set of bridges 32-1 between the outer contour of the rotor discs 20 and the inner circumference of the stator rings 10, is cut by means of a blanking punch-and-die-pair. Moreover, the placement of the bridges 32-1 of the said first set preferably satisfies one or both of the following two features, as illustrated in detail in the enlarged inset in FIG. 5:
the bridges 32-1 connect to the rotor disc 20 at an indent in the outer contour thereof, such that locally the outer circumference of the—to be cut—rotor disc 20 deviates from a virtual circle in radial inward direction;
the bridges 32-1 connect to the stator ring 10 in between two pole teeth 12, i.e. in line with the radial slot 13 there between, which respective pole teeth 12 are thus mutually connected tangentially by a respective bridge 32-1. Ideally in this respect, the respective bridge 32-1 connects to the respective pole teeth 12 exclusively in the tangential direction and not also in radial (inward) direction, such that radially inner faces of pole teeth 12 are (completely) cut in the said first step A in the novel manufacturing method.

By these bridge placements, for example rotor/stator-interference in the end-product electric motor can be reliably avoided and/or magnetic reluctance can be maximized in such he end-product electric motor.

Furthermore, the bridges 32-1 of the said first set each preferably connect to the rotor discs 20 where a respective magnet hole 22 comes close to the outer contour of that rotor disc 20 (not illustrated), in order to improve the mechanical strength thereof due to work hardening in cutting the bridges 32-1.

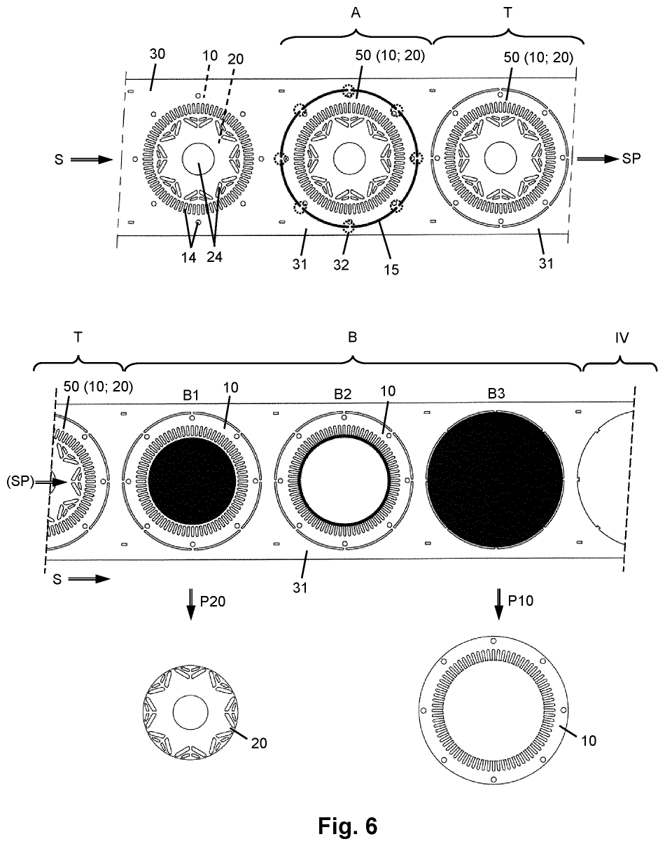

A third elaboration of the novel lamination stack manufacturing method according to the invention is schematically illustrated in FIG. 6. This third elaboration is similar to the second elaboration described hereinabove, with the exception that in the first step A of the third elaboration only one set of eight, mutually spaced elongated holes 15 are pierced through the sheet material 30, namely those holes 15 that follow the outer contour of the—to be cut—stator ring 10. Thus, in this third elaboration the stator ring 10 and the rotor disc 20 remain as a one piece 50 after the first step A in the novel manufacturing method.

Thereafter, in the first stage B1 of the second step B of this third elaboration, the rotor disc 20 is blanked from the sheet material 30 in the conventional manner, i.e. is cut along its entire outer contour. This has the advantage that such outer contour can be formed with high accuracy with the said work hardening being effected along the entirety thereof. Then, in the second stage B2 of this second step B, a thin ring is cut from inside the inner circumference of the stator ring 10, thereby opening up to the radial slots 13—that were pre-formed in the first or second step I; II of the conventional process as stator holes 14—and thus finalizing the inner contour of the stator ring 10. The thus cut ring is ejected from the cutting device as scrap. Finally, in the third stage B3 of the second step B, the stator ring 10 is completely cut loose from the frame part 31 of the sheet material 30 by cutting the bridges 32 that are defined at its outer contour between the said elongated holes 15.

1. A method for manufacturing lamellas (1; 10; 20; 50) from sheet material (30) for a lamination stack thereof, such as a transformer core or a stator or rotor laminate of an electric motor, wherein the lamellas (1; 10; 20; 50) are partially cut loose from the sheet material (30) in a first process step (A) and wherein the lamellas (1; 10; 20; 50) are completely cut loose from the sheet material (30) in a second process step (B).

2. The method for manufacturing lamellas (1; 10; 20; 50) according to claim 1, wherein, in the first process step (A), a respective lamella (1; 10; 20; 50) is partially cut loose by piercing a number of elongated holes (23; 15; 25) along an outer contour thereof, while leaving a corresponding number of connecting bridges (32) between the respective lamella (1; 10; 20; 50) and a frame part (31) of the sheet material (30) or an adjacent lamella (1; 10; 20; 50), and wherein in the second process step (B) the respective lamella (1; 10; 20; 50) is completely cut loose by severing the connecting bridges (32) along the outer contour.

3. A method for manufacturing pairs of lamellas (10, 20; 50) from sheet material (30), the pair of lamellas (10; 20; 50) comprising a stator ring (10) and a rotor disc (20) that are respectively configured for a stator lamination and a rotor lamination of an electric motor, wherein, in a first process step (A), at least the stator ring (10) of a respective lamella pair (10, 20; 50) is partially cut loose from the sheet material (30) by piercing a number of elongated holes (15) along an outer contour thereof, while leaving a corresponding number of connecting bridges (32; 32-2) between the respective lamella pair (10, 20; 50) and a frame part (31) of the sheet material (30) or an adjacent lamella (1; 10; 20; 50), and wherein, in a second process step (B), the connecting bridges (32; 32-2) are severed along the outer contour of the stator ring (10).

4. The method for manufacturing pairs of lamellas (10, 20; 50) according to claim 3, wherein prior to severing the connecting bridges (32; 32-2) along the outer contour of the stator ring (10) in the second process step (B), firstly the rotor disc (20) is cut from the sheet material (30) and, subsequently, also a ring of scrap material is cut from the sheet material (30) on an inner contour of the stator ring (10).

5. The method for manufacturing pairs of lamellas (10, 20; 50) according to claim 3, wherein, in the first process step (A) also the rotor disc (20) of a respective lamella pair (10, 20; 50) is partially cut loose from the sheet material (30) by piercing a number of elongated holes (15) along the outer contour thereof, while leaving a corresponding number of connecting bridges (32; 32-1) between the rotor disc (20) and the stator ring (10) of that respective lamella pair (10, 20; 50).

6. The method for manufacturing pairs of lamellas (10, 20; 50) according to claim 5, wherein prior to severing the connecting bridges (32; 32-2) along the outer contour of the stator ring (10) in the second process step (B), firstly the connecting bridges (32; 32-1) are severed along the outer contour of the rotor disc (20) and, subsequently, these same connecting bridges (32; 32-1) are also severed along an inner contour of the stator ring (10).

7. The method for manufacturing pairs of lamellas (10, 20; 50) according to claim 5, wherein, the connecting bridges between the rotor disc (20) and the stator ring (10) exclusively attach to the stator ring (10) at a slot (13) extending in radial outward direction in an inner contour of the stator ring (10).

8. The method for manufacturing lamellas (1; 10; 20; 50) according to claim 2, wherein, the number of connecting bridges (32) is at least 4 and at most 20.

9. The method for manufacturing lamellas (1; 10; 20; 50) according to claim 8, wherein, a respective lamella (1; 10; 20; 50) has an R-fold rotational symmetry and wherein the number of the connecting bridges (32) amounts to one half, one or two times a numeric value of R.

10. The method for manufacturing lamellas (1; 10; 20; 50) according to claim 2, wherein, in the first process step (A) and as seen in a long direction of the sheet material (30), at least two of the connecting bridges (32) are provided on either side of a respective lamella (1; 10; 20; 50) that partly extend also in the long direction between the respective lamella (1; 10; 20; 50) and the frame part (31).

11. The method for manufacturing lamellas (1; 10; 20; 50) according to claim 2, wherein, in the first process step (A), the connecting bridges (32) are essentially equally spaced along a circumference of a respective lamella (1; 10; 20; 50).

12. The method for manufacturing lamellas (1; 10; 20; 50) according to claim 2, wherein, the connecting bridges (32) connect to a respective lamella (1; 10; 20; 50) at a location of an indent in a general circumference thereof.

13. The method for manufacturing lamellas (1; 10; 20; 50) according to claim 2, wherein, in the first process step (A), the connecting bridges (32) are provided mirror-symmetrically relative to a virtual centerline of a respective lamella (1; 10; 20; 50) oriented in a long direction of the sheet material (30).

14. The method for manufacturing lamellas (1; 10; 20; 50) according to claim 1, wherein, between the first process step (A) and the second process step (B), the lamellas (1; 10; 20; 50) are subjected to a heat treatment and/or are provided with a coating or an adhesive.

15. The method for manufacturing lamellas (1; 10; 20; 50) according to claim 1, wherein, the lamellas (1; 10; 20; 50) have a thickness in a range from 0.05 mm to 0.5 mm.

16. The method for manufacturing pairs of lamellas (10, 20; 50) according to claim 4, wherein, in the first process step (A) also the rotor disc (20) of a respective lamella pair (10, 20; 50) is partially cut loose from the sheet material (30) by piercing a number of elongated holes (15) along the outer contour thereof, while leaving a corresponding number of connecting bridges (32; 32-1) between the rotor disc (20) and the stator ring (10) of that respective lamella pair (10, 20; 50).

17. The method for manufacturing pairs of lamellas (10, 20; 50) according to claim 6, wherein, the connecting bridges between the rotor disc (20) and the stator ring (10) exclusively attach to the stator ring (10) at a slot (13) extending in radial outward direction in the inner contour of the stator ring (10).

18. The method of manufacturing lamellas (1; 10; 20; 50) according to claim 13, wherein the connecting bridges (32) are provided mirror-symmetrically relative to the virtual centerline of the lamella (1; 10; 20; 50) oriented perpendicular to the long direction of the sheet material (30).

19. The method of manufacturing lamellas (1; 10; 20; 50) according to claim 15, wherein a largest or a main dimension of the lamellas (1; 10; 20; 50) is between 500 and 2500 times their thickness.
